(19) United States
(12) Patent Application Publication
(10) Pub. No.: US 2025/0077965 A1
(43) Pub. Date: Mar. 6, 2025

(54) TECHNIQUES FOR IMPLEMENTING FIXED LINEAR OPERATORS IN MACHINE LEARNING MODELS

(71) Applicant: NVIDIA CORPORATION, Santa Clara, CA (US)

(72) Inventors: Matthijs Jules VAN KEIRSBILCK, Berlin (DE); Alexander Georg KELLER, Berlin (DE)

(21) Appl. No.: 18/656,507

(22) Filed: May 6, 2024

Related U.S. Application Data
(60) Provisional application No. 63/580,648, filed on Sep. 5, 2023.

(51) Int. Cl. G06N 20/00

(52) U.S. Cl. CPC G06N 20/00

(57) ABSTRACT

One embodiment of a computer-implemented method includes executing at least one first operation on each component of one or more feature vectors along time and at least one second operation on one or more feature vectors along one or more feature dimensions, where the at least one first operation is based on an analytic function and the at least one second operation is based on a machine learned function.

### CROSS-REFERENCE TO RELATED APPLICATIONS

This application claims priority benefit of the U.S. Provisional Patent Application titled, “FIXED AVERAGING AND SHIFTS IN NEURAL NETWORK MODELS,” filed on Sep. 5, 2023, and having Ser. No. 63/580,648. The subject matter of this related application is hereby incorporated herein by reference.

### BACKGROUND

### Technical Field

Embodiments of the present disclosure relate generally to computer science, artificial intelligence, and machine learning and, more specifically, to techniques for implementing fixed linear operators in machine learning models.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data sets. In turn, the discovered information can be used to guide decisions and/or perform actions related to data.

Within machine learning, neural networks can be trained to perform a wide range of tasks with a high degree of accuracy. Neural networks are therefore becoming widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections.

One drawback of complex neural networks is that these neural networks are oftentimes very computationally expensive to train and to execute after training. For example, within a neural network, each layer generates an output that is typically written to system memory that is external to a processor and then read from the system memory as input into the next layer of the neural network. During training of the neural network, the output of a layer that is written to system memory can be used to update the parameters of that layer. However, writing to and reading from system memory is typically hundreds of times slower than writing to and reading from the memory within a processor. Accordingly, a complex neural network that includes many layers whose outputs are written to and read from system memory can be very computationally expensive to train and to execute after training.

As the foregoing illustrates, what is needed in the art are machine learning models that are more efficient to train and execute.

### SUMMARY

One embodiment of the present disclosure sets forth a computer-implemented method. The method includes executing at least one first operation on each component of one or more feature vectors along time and at least one second operation on one or more feature vectors along one or more feature dimensions. The at least one first operation is based on an analytic function and the at least one second operation is based on a machine learned function.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques replace learned temporal convolution layers of neural networks with fixed analytic functions and/or linear operators such as fixed averaging and shifts. The fixed analytic functions and/or linear operators can be less complex than learned temporal convolution layers, allowing neural networks that include the fixed analytic functions and/or linear operators to execute faster. When the fixed analytic functions and/or linear operators replace learned temporal convolution layers within neural networks, outputs of those fixed analytic functions and/or linear operators can be stored on the memory within a processor, rather than being written to and read from system memory that is external to the processor. Accordingly, neural networks including analytic functions, linear operators, and/or fixed temporal convolutions can be less computationally expensive to train and to execute relative to neural networks that include learned temporal convolutional layers. In addition, neural networks that include analytic functions, linear operators, and/or fixed temporal convolutions can generate results that are comparable to results that are generated by neural networks that include learned temporal convolution layers. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the computing device of FIG. 1, according to various embodiments;

FIG. 3 is a more detailed illustration of the machine learning model of FIG. 1, according to various embodiments;

FIG. 4A illustrates an exemplar visualization of a temporal convolution layer in a neural network, according to the prior art;

FIG. 4B illustrates another exemplar visualization of a temporal convolution layer in a neural network, according to the prior art;

FIG. 4C illustrates an exemplar visualization of fixed averaging, shifts, and first and second derivatives that can replace the temporal convolution layer of FIG. 4B, according to various embodiments;

FIG. 4D illustrates an exemplar visualization of fixed averaging and shifts that can replace the temporal convolution layer of FIG. 4B, according to various other embodiments;

FIG. 5 is a flow diagram of method steps for processing data using a machine learning model that includes fixed linear operator portions, according to various embodiments; and

FIG. 6 is a flow diagram of method steps for training a machine learning model that includes fixed linear operator portions, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for processing data using machine learning models that include fixed linear operator portions instead of learned temporal convolution layers. In some embodiments, the machine learning models are neural networks in which one or more learned temporal convolution layers are replaced with analytic function(s) and/or linear operator(s), such as averaging data from multiple time steps and copying data from different time steps. In such cases, outputs of the analytic function(s) and/or linear operator(s) do not need to be written to and read from system memory that is external to a processor. Alternatively, in some embodiments, one or more learned temporal convolution layers can be replaced with fixed convolution layer(s). In some embodiments, the analytic function(s), linear operator(s), and/or fixed convolution layer(s) are followed by learned feature convolution layers in the neural networks. In such cases, parameters of the feature convolution layers can be updated during training of the neural network, while the analytic function(s), linear operator(s), and/or fixed convolution layers are not modified during the training.

The machine learning models disclosed herein have many real-world applications. For example, those machine learning models could be used in audio processing, such as generating text from audio of speech. As another example, those machine learning models may be used in video processing, such as video understanding and generation. As another example, those machine learning models may be used in time series analysis and prediction, such as weather forecasting.

The above examples are not in any way intended to be limiting. As persons skilled in the art will appreciate, as a general matter, the machine learning models described herein can be implemented in any suitable application.

### System Overview

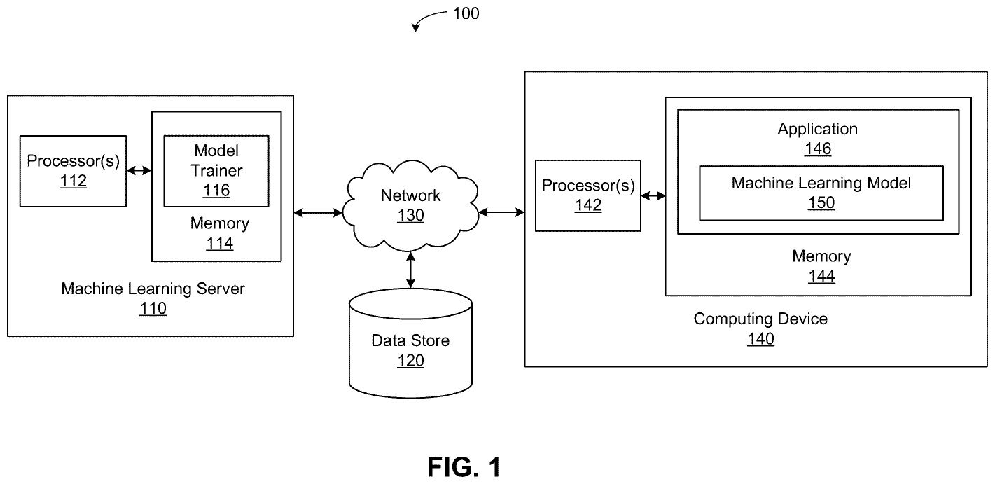

FIG. 1 illustrates a block diagram of a computer-based system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor 112 receives user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

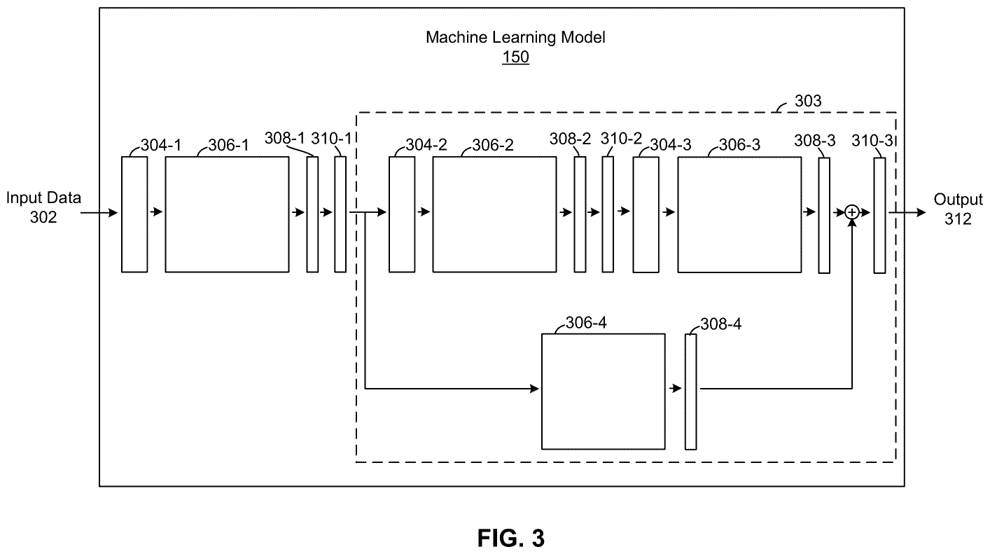

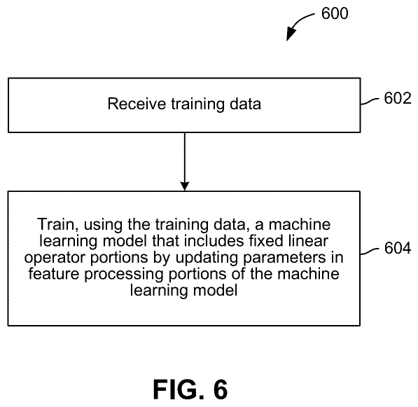

In some embodiments, the model trainer 116 is configured to train one or more machine learning models, including a machine learning model 150 that includes fixed linear operator portions, such as analytic functions, linear operators, and/or fixed convolution layers that are defined in program code. Techniques that the model trainer 116 can use to train the machine learning model(s) are discussed in greater detail below in conjunction with FIGS. 3 and 6. Training data and/or trained (or deployed) machine learning models, including the machine learning model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

As shown, an application 146 that uses the machine learning model 150 that includes fixed linear operator portions is stored in a system memory 144, and executes on a processor 142, of the computing device 140. Once trained, the machine learning model 150 can be deployed in any suitable manner, such as via the application 146. For example, when the machine learning model 150 is a speed-to-text model, the machine learning model 150 can be deployed to a virtual assistant application, a word processing application, or a search engine application, among other things.

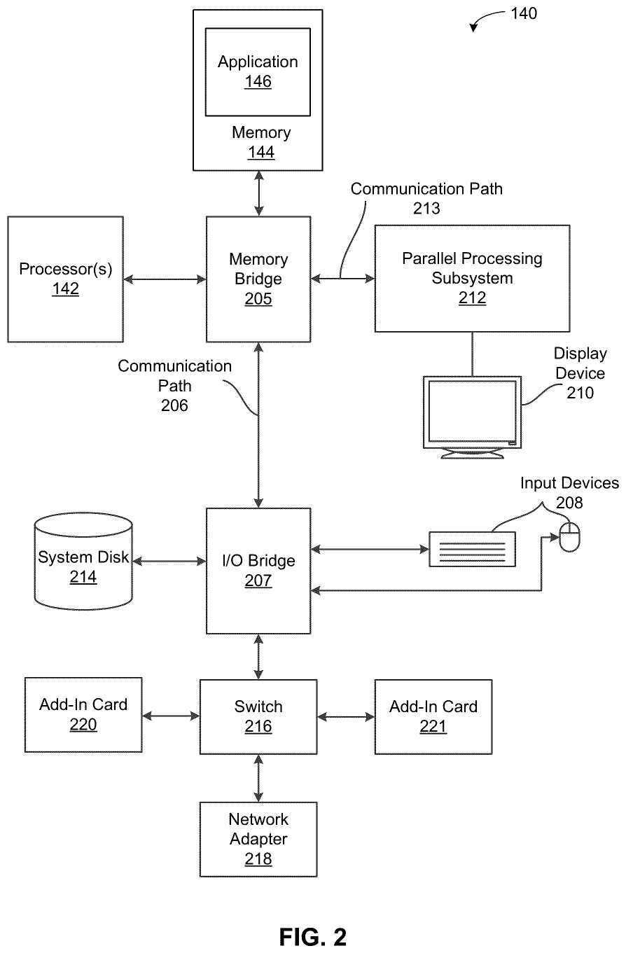

FIG. 2 is a block diagram illustrating the computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, the machine learning server 110 can include one or more similar components as the computing device.

In various embodiments, the computing device 140 includes, without limitation, the processor(s) 142 and the memory(ies) 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e, evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 208, but may receive equivalent input information by receiving commands (e, responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 144 includes at least one device driver configured to manage the processing operations of the one or more PPUs within parallel processing subsystem 212. In addition, the system memory 144 includes the model trainer 116. Although described herein primarily with respect to the model trainer 116, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 142 includes the primary processor of machine learning server 110, controlling and coordinating operations of other system components. In some embodiments, the processor(s) 142 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 144 could be connected to the processor(s) 142 directly rather than through memory bridge 205, and other devices may communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Fixed Linear Operators in Machine Learning Models

FIG. 3 is a more detailed illustration of the machine learning model 150 of FIG. 1, according to various embodiments. Although a particular architecture of the machine learning model 150 is shown for illustratively purposes, techniques disclosed herein can be used to replace temporal convolution layers in machine learning models having any technically feasible architecture.

As shown, the machine learning model 150 is a neural network that processes input data 302 to generate an output 312. For example, the machine learning model 150 could be a speech-to-text model that takes as input a frequency representation, such as a spectrogram, of audio data of speech and outputs text corresponding to the speech.

Illustrative, machine learning model 150 includes fixed linear operator portions 304-1 to 304-3 (referred to herein collectively as fixed linear operator portions 304 and individually as a fixed linear operator portion 304), feature convolution layers 306-1 to 306-4 (referred to herein collectively as feature convolution layers 306 and individually as a feature convolution layer 306), batch normalizations 308-1 to 308-4 (referred to herein collectively as batch normalizations 308 and individually as a batch normalization 308), and activation layers 310-1 to 310-3 (referred to herein collectively as activation layers 310 and individually as an activation layer 310). Illustratively, the fixed linear operator portions 304-2 to 304-3, the feature convolution layers 306-2 to 306-4, the batch normalizations 308-2 to 308-4, and the activation layers 310-2 to 310-3 are included in a residual block 303. Although one residual block 303 is shown for illustrative purposes, in some embodiments, a machine learning model can include any technically feasible number of repeating residual blocks. In some embodiments, each of the fixed linear operator portions 304 can process data by averaging data from multiple time steps; copying data from a different time step (or the same time step), which is also referred to herein a “shift”; first derivatives computed on data; and/or second derivatives computed on data, as discussed in greater detail below. The fixed linear operator portions 304 can replace temporal convolutions having parameters that need to be learned through training of the machine learning model 150. In some embodiments, the fixed linear operator portions 304 can be implemented as analytic functions and/or linear operators that are defined in program code. It should be understood that the fixed linear operator portions 304 can be less complex, and therefore less computationally expensive to execute, than learned convolutions. For example, an analytic function for copying data can access the data from memory, rather than performing the matrix multiplication in a convolution. In some other embodiments, the fixed linear operator portions 304 can be implemented as fixed convolutions, such as matrices that include predefined parameter values. Although the machine learning model 150 having a particular architecture is shown for illustrative purposes, in some embodiments, a machine learning model that includes fixed linear operator portions that replace learned temporal convolutions can have any technically feasible architecture. In some embodiments, fixed linear operator portions can replace the temporal convolution layers in machine learning models that are decomposed orthogonally along time and features so as to perform processing in time and processing features (e.g., 1×1 convolutions across features) in an alternating manner. Although fixed linear operator portions 304 are shown for illustrative purposes, in some embodiments, a machine learning model can include one or more temporal convolution layers that are trainable in addition to one or more fixed linear operator portions.

Convolutions in some machine learning models are decomposed into two one-dimensional (1D) components, orthogonally along time and features. In such machine learning models, a first layer, which is referred to herein as a “temporal convolution layer,” learns a set of 1D convolution filters, one for each feature, and convolves the 1D convolution filters with respect to activations across the temporal dimension. A second layer of the machine learning models, which is referred to herein as a “feature convolution layer,” learns to combine the different features via a linear transformation, which can be followed by a batch normalization and an activation layer, such as a ReLU layer. In some embodiments, the temporal convolution layers of machine learning models can be replaced by fixed linear operator portions, such as fixed linear operator portions 304, while the feature convolution layers of the machine learning models, such as the feature convolution layers 306, can remain learnable. For example, in some embodiments, the feature convolution layers 306 can be feedforward layers including parameters that are learned during training of the machine learning model 150. In some other embodiments, the temporal convolution layers of a machine learning model can be replaced by finite impulse response (FIR) filters and/or infinite impulse response (IIR) filters, each with parameters and/or a number of taps that can be machine learned or predefined.

As described, in some embodiments, each of the fixed linear operator portions 304 can be implemented as one or more analytic functions and/or linear operators for averaging data from multiple time steps, copying data from a different time step (or the same time step), computing first derivatives on data, and/or computing second derivatives on data. In such cases, the analytic function(s) and/or linear operator(s) are less computationally complex, and can therefore execute faster, than learned temporal convolutions. In addition, the analytic function(s) and/or linear operator(s) can be merged, or “fused,” with the subsequent layer by joining operations associated with the analytic function(s) and/or linear operator(s) and the subsequent layer such that outputs of the analytic function(s) and/or linear operator(s) are not written to and read from system memory that is external to a processor, during training of the machine learning model and during execution of the machine learning model after training. In some embodiments, the analytic function(s) and/or linear operator(s) can be machine learned or predefined. In some embodiments, the analytic function(s) and/or linear operator(s) can include at least one of average(s), shifted average(s), cop(ies), shifted cop(ies), difference(s), shifted difference(s), central difference(s), shifted central difference(s), finite differenc(es), and/or shifted finite differenc(es), as described in greater detail below. In some other embodiments, each of the fixed linear operator portions 304 can be implemented as fixed (as opposed to learned) convolution layers that represent averaging data from multiple time steps, copying data from different time steps, computing first derivatives on data, and/or computing second derivatives on data.

The intuition for replacing temporal convolution layers in neural networks with fixed linear operator portions can be provided by Gabor functions. Gabor functions are the product of a cosine/sine pair and a Gaussian function, parametrized by the center frequency f and variance σ² (showing only the cosine component):

$${g}_{f , σ} ( x ) = \frac{1}{\sqrt{2 π} σ} {e}^{- \frac{{x}^{2}}{2 {σ}^{2}}} cos ( 2 π fx ) . \qquad ( 1 )$$

Experience has shown that the parameters of Gabor functions can be fitted to learned weights in the temporal convolution layers of neural networks via a minimization technique. After the fitting, the parameter values (rather than the whole function) can be stored for use in some embodiments. In such cases, Gabor functions with the stored parameter values can be used as analytic functions that replace corresponding temporal convolution layers in a neural network. Further, experience has shown that fixed linear operator portions that are simpler than Gabor functions can be used to replace temporal convolution layers in neural networks. As described, the fixed linear operator portions can be less computationally expensive, as well as more interpretable, than learned temporal convolution layers of a neural network.

By visualizing the trained weights in neural networks that include temporal convolution layers and the Gabor function fitting, described above, experience has shown that the learned 1D filters in such neural networks resemble linear operations such as averaging, copies, and derivatives. In particular, experience has shown that 1D convolutions in the neural networks compute approximately the same function except for a shift, resembling a wavelet or sharpening filter. Accordingly, some embodiments replace temporal convolution layers in neural networks with analytic functions, linear operators, and/or fixed convolution layers.

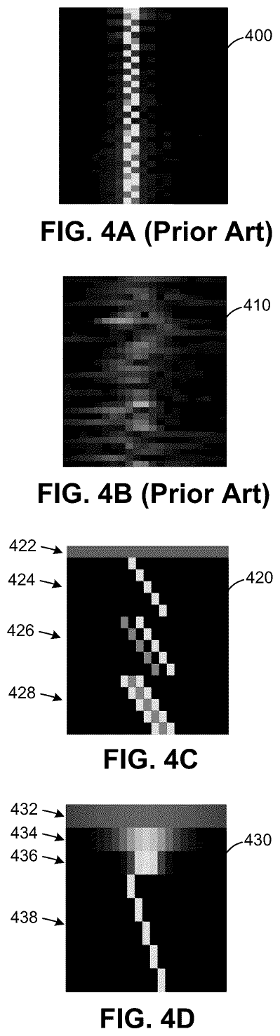

FIG. 4A illustrates an exemplar visualization 400 of a temporal convolution layer in a neural network, according to the prior art. As shown, the visualization 400 indicates the weight values of a learned filter bank that is the first temporal convolution layer (corresponding to the fixed linear operator portion 304-1) of the QuartzNet neural network. Each row of the visualization 400 indicates the weight values of a 1D temporal convolution filter. In the visualization 400, green colors indicate positive weight values, red colors indicate negative weight values, and the brightness of a color indicates how large a corresponding weight value is (e.g., black indicates a weight value of 0, bright red indicates a large negative weight value, etc.). The width of the visualization 400 is the width of the temporal filter kernel, and each row of the visualization 400 is used to process one feature. Although described herein with respect to the QuartzNet neural network as an illustrative example, techniques disclosed herein can be used to replace temporal convolution layers in machine learning models having any technically feasible architecture, such as the Conformer, Squeezeformer, FastConformer, and CitriNet architectures. In some embodiments, techniques disclosed herein can be used to replace the temporal convolution layers in machine learning models that are decomposed orthogonally along time and features so as to perform processing in time and processing features in an alternating manner.

The temporal convolution layer represented by the visualization 400 takes as input a frequency representation (e.g., a Fourier transform) of audio data for speech, and the temporal convolution layer performs a temporal convolution on such an input. Illustratively, the visualization 400 includes a zig-zag pattern corresponding to copying two adjacent features, the feature from a current time step and the feature from one previous time step. A subsequent feature convolution layer can compare the copies of adjacent features with each other. In some embodiments, the temporal convolution layer represented by the visualization 400 can be replaced by analytic function(s) and/or linear operator(s) for the same copying operations, in which odd numbered copies that are shifted by one number (e.g., 0) of timesteps and even numbered copies are shifted by a different number (e.g., −1) of timesteps, or a fixed convolution layer for the same copying operations. As described, the analytic function(s) and/or linear operator(s) are less computationally complex, and can therefore execute faster, than learned temporal convolutions. In addition, the analytic function(s) and/or linear operator(s) can be fused with a subsequent layer such that outputs of the analytic function(s) and/or linear operator(s) are not written to and read from system memory that is external to a processor.

FIG. 4B illustrates another exemplar visualization 410 of a temporal convolution layer in a neural network, according to the prior art. As shown, the visualization 410 indicates the weight values of a learned filter bank that is the temporal convolution layer in the fourth residual block (corresponding to the fixed linear operator portion 304-2) of the QuartzNet neural network. Similar to the visualization 400, each row of the visualization 410 indicates the weight values of a 1D temporal convolution filter.

Illustratively, in many rows of each of the 1D convolutional filters represented by the visualization 410, most of the weights at the center of the 1D convolutional filters are larger in magnitude than weights further from the center, meaning the weights are computing an average of features across several time steps. The non-zero weights in a row tend to have the same sign, meaning the filter computes a sort of smoothed copy of a feature, sometimes with flipped sign. Some rows in the visualization 410 have positive weights on the left and negative weights on the right, meaning the 1D convolutional filter computes edges or differences. Early layers on the left of the filters represented by the visualization 410 are much sharper than in deeper layers. In many layers (not shown), there are rows where all weights are similar, so the filter computes an average. In addition, many filters are not centered, which may indicate too large a degree of freedom in the learnable convolutional weights.

FIG. 4C illustrates an exemplar visualization 420 of fixed averaging, shifts, and first and second derivatives that can replace the temporal convolution layer of FIG. 4B, according to various embodiments. As shown, the visualization 420 indicates fixed weight values for a temporal convolution in the fourth residual block of the QuartzNet neural network, such as weight values that can be used in the fixed linear operator portion 304-2. In some embodiments, the weight values indicated by the visualization 420 can be used to replace the weight values indicated by the visualization 410, described above in conjunction with FIG. 4B. Although a fixed temporal convolution layer that includes certain weight values is shown as a reference example, in some embodiments, one or more analytic functions and/or linear operators that perform the same linear operator computations can be used instead of a fixed temporal convolution layer. As described, the analytic function(s) and/or linear operator(s) are less computationally complex, and can therefore execute faster than, learned temporal convolutions, and the analytic function(s) and/or linear operator(s) can be fused with a subsequent layer such that outputs of the analytic function(s) and/or linear operator(s) are not written to and read from system memory.

As shown in FIG. 4C, a fixed averaging filter 422 of width W that averages features over all of the time steps can use 1/W as the value for all weights, while fixed filters implementing a copy 424 of features can use zero weights except for a 1.0 in the center. The wider and narrower averages permit different details in input audio data to be identified. Further, the wider and narrower averages provide references that the copy 424 of features can be compared against. In some embodiments, the averages can include moving averages, cumulative moving averages, and/or exponentially moving averages. For fixed filters implementing first derivatives 426 of features and fixed filters implementing second derivatives 428 of features, central finite differences can be used to provide second order accuracy.

As described, most learned filters are not centered, meaning the filters shift their input left or right in the time dimension. Doing so permits the next layer to compare features across time, which is useful for processing sequential data such as speech. In some embodiments, shifts are also added to fixed linear operator portions that replace temporal convolution layers in neural networks. As shown in FIG. 4C, the fixed filters implementing copy 424, the fixed filters implementing first derivatives 426, and the fixed filters implementing second derivatives 428 include filters 5 shifts in time: {−2, −1, 0, +1, +2}. Shift 0 corresponds to copying an input, shift −2 corresponds to copying from 2 steps prior, shift −1 corresponds to copying from 1 time step prior, shift 1 corresponds to copying from 1 time step later, shift 2 corresponds to copying from 2 time steps later.

In some embodiments, 2N+1 shifts in 1D convolutions can be implemented by offsetting the weights in the respective filters from the center by {−N, . . . , 0, . . . , +N} steps. In some embodiments, different strides than 1 can be used, such as a stride of 2, for which 3 shifts can be −2, 0, and 2.

FIG. 4D illustrates an exemplar visualization 430 of fixed averaging and shifts that can replace the temporal convolution layer of FIG. 4B, according to various other embodiments. As shown, the visualization 430 indicates fixed weight values for a temporal convolution in the fourth residual block of the QuartzNet neural network, such as weight values that can be used in the fixed linear operator portion 304-2. In some embodiments, the weight values indicated by the visualization 420 can be used to replace the weight values indicated by the visualization 410, described above in conjunction with FIG. 4B. Although a fixed temporal convolution layer that includes certain weight values is shown as a reference example, in some embodiments, one or more analytic functions and/or linear operators that perform the same linear operator computations can be used instead of a fixed temporal convolution layer. As described, the analytic function(s) and/or linear operator(s) are less computationally complex, and can therefore execute faster than, learned temporal convolutions, and the analytic function(s) and/or linear operator(s) can be fused with a subsequent layer such that outputs of the analytic function(s) and/or linear operator(s) are not written to and read from system memory.

Illustratively, the visualization 430 indicates that the temporal convolution in the fourth residual block of the QuartzNet neural network can include filters implementing Gaussian averaging of a full width 432, Gaussian averaging of a half width 434, Gaussian averaging of a quarter width 436, and shifted copies 438 that can be considered Gaussian averages of 0 width and a shift. Using only the shifted copies 438, the feature convolution layer following the temporal convolution layer in the neural network will be able to compute differences between adjacent time steps, meaning that providing such features in the form of first and second derivatives is redundant. That is, the following feature convolution layer can learn to produce the first derivatives 426 and the second derivatives 428 of the visualization 420, without requiring the first derivatives 426 or the second derivatives 428 to be defined in the temporal convolution layer. Accordingly, only averaging (e.g., the averaging 432, 434, and 436) and the shifted copies (e., the shifted copies 438) are used in some embodiments to replace learned temporal convolution layers of a machine learning model, while filters implementing first and second derivatives are not required because the subsequent feature convolution layers can learn to produce the first and second derivatives.

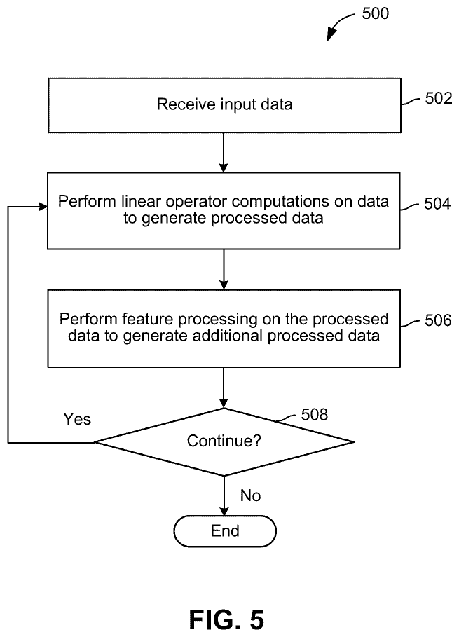

FIG. 5 is a flow diagram of method steps for processing data using a machine learning model that includes fixed linear operator portions, according to various embodiments. Although the method steps are described in conjunction with the systems of FIGS. 1-3, persons skilled in the art will understand that any system configured to perform the method steps in any order falls within the scope of the present embodiments.

As shown, a method 500 begins at step 502, where the application 146 receives input data. Any suitable input data can be received in some embodiments. For example, in some embodiments, the input data can include a frequency representation of audio data, such as a spectrogram of audio data.

At step 504, the application 146 performs linear operator computations on data to generate processed data. In some embodiments, the linear operator computations include averaging the data and/or copying the data, with and/or without time shifts. In some embodiments, the linear operator computations include averaging the data over different numbers of time steps. In some embodiments, the linear operator computations include copying data from one or more previous time steps, the current time step, and one or more subsequent time steps. For example, data can be copied from −2, −1, 0, 1, and 2 time steps in some embodiments. More generally, in some embodiments, the linear operator computations include at least one of average(s), shifted average(s), cop(ies), shifted cop(ies), difference(s), shifted difference(s), central difference(s), shifted central difference(s), finite differenc(es), and/or shifted finite differenc(es), as described in greater detail below. The linear operator computations can be implemented in any technically feasible manner in some embodiments. For example, in some embodiments, the linear operator computations can be implemented using analytic function(s) and/or linear operator(s). As another example, in some embodiments, the linear operator computations can be implemented using one or more fixed (as opposed to learned) temporal convolution layers of a neural network.

At step 506, the application 146 performs feature processing on the processed data to generate additional processed data. Any technically feasible feature processing operations can be performed in some embodiments. In some embodiments, the feature processing operations can include inputting the processed data into at least one learned feature convolution layer of a trained machine learning model, such as a trained neural network, that outputs the additional processed data.

At step 508, the application 146 determines whether to continue processing the data. In some embodiments, the application 146 can continue processing the data if there are additional layers of the machine learning model. If the application 146 determines to not continue processing the data, then the method 500 ends.

On the other hand, if the application 146 determines to continue processing the data, then the method 500 returns to step 504, where the application 146 again performs linear operator computations on the data to generate additional processed data.

FIG. 6 is a flow diagram of method steps for training a machine learning model that includes fixed linear operator portions, according to various embodiments. Although the method steps are described in conjunction with the systems of FIGS. 1-3, persons skilled in the art will understand that any system configured to perform the method steps in any order falls within the scope of the present embodiments.

As shown, a method 600 begins at step 602, where the model trainer 116 receives training data for training a machine learning model. Any suitable training data can be received in some embodiments, and the particular training data that is used can depend on the machine learning model being trained. For example, when the machine learning model is a speech-to-text model, the training data can include audio of speech and corresponding text for training the speech-to-text model.

At step 604, the model trainer 116 uses the training data to train a machine learning model that includes fixed linear operator portions by updating parameters in trainable feature processing portions of the machine learning model. Any technically feasible training technique, such as backpropagation with gradient descent or a variation thereof, can be employed to train the machine learning model. In some embodiments, the fixed linear operator portions are not updated during training. In some other embodiments, the machine learning model can include one or more temporal convolution layers that are trainable in addition to the fixed linear operator portions. In such cases, parameters of the trainable temporal convolution layers can be updated during training. Although described herein primarily with respect to training a machine learning model that includes fixed linear operator portions, in some embodiments, fixed linear operator portions can be used to replace one or more temporal convolution layers of a previously trained machine learning model.

In sum, techniques are disclosed for processing data using machine learning models that include fixed linear operators instead of learned temporal convolution layers. In some embodiments, the machine learning models are neural networks in which one or more learned temporal convolution layers are replaced with analytic function(s) and/or linear operator(s), such as averaging data from multiple time steps and copying data from different time steps. In such cases, outputs of the analytic function(s) and/or linear operator(s) do not need to be written to and read from system memory that is external to a processor. Alternatively, in some embodiments, one or more learned temporal convolution layers can be replaced with fixed convolution layer(s). In some embodiments, the analytic function(s), linear operator(s), and/or fixed convolution layer(s) are followed by learned feature convolution layers in the neural networks. In such cases, parameters of the feature convolution layers can be updated during training of the neural network, while the analytic function(s), linear operator(s), and/or fixed convolution layers are not modified during the training.

At least one technical advantage of the disclosed techniques relative to the prior art is that the disclosed techniques replace learned temporal convolution layers of neural networks with fixed analytic functions and/or linear operators such as fixed averaging and shifts. The fixed analytic functions and/or linear operators can be less complex than learned temporal convolution layers, allowing neural networks that include the fixed analytic functions and/or linear operators to execute faster. When the fixed analytic functions and/or linear operators replace learned temporal convolution layers within neural networks, outputs of those fixed analytic functions and/or linear operators can be stored on the memory within a processor, rather than being written to and read from system memory that is external to the processor.

Accordingly, neural networks including analytic functions, linear operators, and/or fixed temporal convolutions can be less computationally expensive to train and to execute relative to neural networks that include learned temporal convolutional layers. In addition, neural networks that include analytic functions, linear operators, and/or fixed temporal convolutions can generate results that are comparable to results that are generated by neural networks that include learned temporal convolution layers. These technical advantages represent one or more technological improvements over prior art approaches.

1. In some embodiments, a computer-implemented method comprises executing at least one first operation on each component of one or more feature vectors along time and at least one second operation on one or more feature vectors along one or more feature dimensions, wherein the at least one first operation is based on an analytic function and the at least one second operation is based on a machine learned function.

2. The computer-implemented method of clause 1, wherein the analytic function includes at least one of a Gaussian or a Gabor function.

3. The computer-implemented method of clauses 1 or 2, wherein one or more parameters of the analytic function are at least one of machine learned or manually selected.

4. The computer-implemented method of any of clauses 1-3, wherein at least one operation on the one or more feature vectors along time is computed by at least one of a finite impulse response (FIR) filter or an infinite impulse response (IIR) filter with a selected number of taps.

5. The computer-implemented method of any of clauses 1-4, wherein one or more parameters of the at least one of the FIR filter or the IIR filter are at least one of machine learned or manually selected.

6. The computer-implemented method of any of clauses 1-5, wherein the number of taps is at least one of machine learned or manually selected.

7. The computer-implemented method of any of clauses 1-6, wherein the at least one first operation includes a discrete linear operator.

8. The computer-implemented method of any of clauses 1-7, wherein the discrete linear operator includes at least one of an average, a copy, a difference, a central difference, or a finite difference.

9. The computer-implemented method of any of clauses 1-8, wherein the discrete linear operator is shifted in time by one or more steps.

10. The computer-implemented method of any of clauses 1-9, wherein at least one part of a convolution along time is replaced by at least one of a shifted copy, a shifted average, a shifted difference, or a shifted central difference.

11. The computer-implemented method of any of clauses 1-10, wherein the discrete linear operator is shifted by one number of timesteps and at least one other linear operator is shifted by another number of timesteps.

12. The computer-implemented method of any of clauses 1-11, wherein each odd numbered linear operator is shifted by the one number of timesteps and each even linear operator is shifted by the another number of timesteps.

13. The computer-implemented method of any of clauses 1-12, wherein a width of the average is at least one of machine learned or manually specified.

14. The computer-implemented method of any of clauses 1-13, wherein the discrete linear operator is used to set one or more initial weights of a convolution operation that are subsequently refined by machine learning.

15. The computer-implemented method of any of clauses 1-14, wherein the at least one first operation includes at least two averages of different widths.

16. The computer-implemented method of any of clauses 1-15, wherein the at least one first operation includes at least one average computed via at least one of moving averages, cumulative moving averages, or exponentially moving averages.

17. The computer-implemented method of any of clauses 1-16, wherein the at least one first operation includes at least one average computed via one or more Gaussian filters.

18. The computer-implemented method of any of clauses 1-17, wherein the analytic function and the machine learned function are implemented as a single fused operation, thereby avoiding intermediate accesses to global memory.

19. The computer-implemented method of any of clauses 1-18, wherein the analytic function does not include learnable parameters, and at least one of intermediate output activations or gradients of the analytic function are not written to global memory for at least one of training or optimization.

20. In some embodiments, one or more non-transitory computer-readable media store instructions that, when executed by at least one processor, cause the at least one processor to perform the steps of executing at least one first operation on each component of one or more feature vectors along time and at least one second operation on one or more feature vectors along one or more feature dimensions, wherein the at least one first operation is based on an analytic function and the at least one second operation is based on a machine learned function.

21. The one or more non-transitory computer-readable media of clause 20, wherein the analytic function includes at least one of a Gaussian or a Gabor function.

22. The one or more non-transitory computer-readable media of clauses 20 or 21, wherein one or more parameters of the analytic function are at least one of machine learned or manually selected.

23. The one or more non-transitory computer-readable media of any of clauses 20-22, wherein at least one operation on the one or more feature vectors along time is computed by at least one of a finite impulse response (FIR) filter or an infinite impulse response (IIR) filter with a selected number of taps.

24. The one or more non-transitory computer-readable media of any of clauses 20-23, wherein one or more parameters of the at least one of the FIR filter or the IIR filter are at least one of machine learned or manually selected.

25. The one or more non-transitory computer-readable media of any of clauses 20-24, wherein the number of taps is at least one of machine learned or manually selected.

26. The one or more non-transitory computer-readable media of any of clauses 20-25, wherein the at least one first operation includes a discrete linear operator.

27. The one or more non-transitory computer-readable media of any of clauses 20-26, wherein the discrete linear operator includes at least one of an average, a copy, a difference, a central difference, or a finite difference.

28. The one or more non-transitory computer-readable media of any of clauses 20-27, wherein the discrete linear operator is shifted in time by one or more steps.

29. The one or more non-transitory computer-readable media of any of clauses 20-28, wherein at least one part of a convolution along time is replaced by at least one of a shifted copy, a shifted average, a shifted difference, or a shifted central difference.

30. The one or more non-transitory computer-readable media of any of clauses 20-29, wherein the discrete linear operator is shifted by one number of timesteps and at least one other linear operator is shifted by another number of timesteps.

31. The one or more non-transitory computer-readable media of any of clauses 20-30, wherein each odd numbered linear operator is shifted by the one number of timesteps and each even linear operator is shifted by the another number of timesteps.

32. The one or more non-transitory computer-readable media of any of clauses 20-31, wherein a width of the average is at least one of machine learned or manually specified.

33. The one or more non-transitory computer-readable media of any of clauses 20-32, wherein the discrete linear operator is used to set one or more initial weights of a convolution operation that are subsequently refined by machine learning.

34. The one or more non-transitory computer-readable media of any of clauses 20-33, wherein the at least one first operation includes at least two averages of different widths.

35. The one or more non-transitory computer-readable media of any of clauses 20-34, wherein the at least one first operation includes at least one average computed via at least one of moving averages, cumulative moving averages, or exponentially moving averages.

36. The one or more non-transitory computer-readable media of any of clauses 20-35, wherein the at least one first operation includes at least one average computed via one or more Gaussian filters.

37. The one or more non-transitory computer-readable media of any of clauses 20-36, wherein the analytic function and the machine learned function are implemented as a single fused operation, thereby avoiding intermediate accesses to global memory.

38. The one or more non-transitory computer-readable media of any of clauses 20-37, wherein the analytic function does not include learnable parameters, and at least one of intermediate output activations or gradients of the analytic function are not written to global memory for at least one of training or optimization.

39. In some embodiments, a system comprises one or more memories storing instructions, and one or more processors that are coupled to the one or more memories and, when executing the instructions, are configured to execute at least one first operation on each component of one or more feature vectors along time and at least one second operation on one or more feature vectors along one or more feature dimensions, wherein the at least one first operation is based on an analytic function and the at least one second operation is based on a machine learned function.

Any and all combinations of any of the claim elements recited in any of the claims and/or any elements described in this application, in any fashion, fall within the contemplated scope of the present disclosure and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
executing at least one first operation on each component of one or more feature vectors along time and at least one second operation on one or more feature vectors along one or more feature dimensions,
wherein the at least one first operation is based on an analytic function and the at least one second operation is based on a machine learned function.

2. The computer-implemented method of claim 1, wherein the analytic function includes at least one of a Gaussian or a Gabor function.

3. The computer-implemented method of claim 1, wherein one or more parameters of the analytic function are at least one of machine learned or manually selected.

4. The computer-implemented method of claim 1, wherein at least one operation on the one or more feature vectors along time is computed by at least one of a finite impulse response (FIR) filter or an infinite impulse response (IIR) filter with a selected number of taps.

5. The computer-implemented method of claim 4, wherein one or more parameters of the at least one of the FIR filter or the IIR filter are at least one of machine learned or manually selected.

6. The computer-implemented method of claim 4, wherein the number of taps is at least one of machine learned or manually selected.

7. The computer-implemented method of claim 1, wherein the at least one first operation includes a discrete linear operator.

8. The computer-implemented method of claim 7, wherein the discrete linear operator includes at least one of an average, a copy, a difference, a central difference, or a finite difference.

9. The computer-implemented method of claim 8, wherein the discrete linear operator is shifted in time by one or more steps.

10. The computer-implemented method of claim 9, wherein at least one part of a convolution along time is replaced by at least one of a shifted copy, a shifted average, a shifted difference, or a shifted central difference.

11. The computer-implemented method of claim 9, wherein the discrete linear operator is shifted by one number of timesteps and at least one other linear operator is shifted by another number of timesteps.

12. The computer-implemented method of claim 11, wherein each odd numbered linear operator is shifted by the one number of timesteps and each even linear operator is shifted by the another number of timesteps.

13. The computer-implemented method of claim 8, wherein a width of the average is at least one of machine learned or manually specified.

14. The computer-implemented method of claim 7, wherein the discrete linear operator is used to set one or more initial weights of a convolution operation that are subsequently refined by machine learning.

15. The computer-implemented method of claim 1, wherein the at least one first operation includes at least two averages of different widths.

16. The computer-implemented method of claim 1, wherein the at least one first operation includes at least one average computed via at least one of moving averages, cumulative moving averages, or exponentially moving averages.

17. The computer-implemented method of claim 1, wherein the at least one first operation includes at least one average computed via one or more Gaussian filters.

18. The computer-implemented method of claim 1, wherein the analytic function and the machine learned function are implemented as a single fused operation, thereby avoiding intermediate accesses to global memory.

19. The computer-implemented method of claim 1, wherein the analytic function does not include learnable parameters, and at least one of intermediate output activations or gradients of the analytic function are not written to global memory for at least one of training or optimization.

20. One or more non-transitory computer-readable media storing instructions that, when executed by at least one processor, cause the at least one processor to perform the steps of:
executing at least one first operation on each component of one or more feature vectors along time and at least one second operation on one or more feature vectors along one or more feature dimensions,
wherein the at least one first operation is based on an analytic function and the at least one second operation is based on a machine learned function.

21. The one or more non-transitory computer-readable media of claim 20, wherein the analytic function includes at least one of a Gaussian or a Gabor function.

22. The one or more non-transitory computer-readable media of claim 20, wherein one or more parameters of the analytic function are at least one of machine learned or manually selected.

23. The one or more non-transitory computer-readable media of claim 20, wherein at least one operation on the one or more feature vectors along time is computed by at least one of a finite impulse response (FIR) filter or an infinite impulse response (IIR) filter with a selected number of taps.

24. The one or more non-transitory computer-readable media of claim 23, wherein one or more parameters of the at least one of the FIR filter or the IIR filter are at least one of machine learned or manually selected.

25. The one or more non-transitory computer-readable media of claim 23, wherein the number of taps is at least one of machine learned or manually selected.

26. The one or more non-transitory computer-readable media of claim 20, wherein the at least one first operation includes a discrete linear operator.

27. The one or more non-transitory computer-readable media of claim 26, wherein the discrete linear operator includes at least one of an average, a copy, a difference, a central difference, or a finite difference.

28. The one or more non-transitory computer-readable media of claim 27, wherein the discrete linear operator is shifted in time by one or more steps.

29. The one or more non-transitory computer-readable media of claim 28, wherein at least one part of a convolution along time is replaced by at least one of a shifted copy, a shifted average, a shifted difference, or a shifted central difference.

30. The one or more non-transitory computer-readable media of claim 28, wherein the discrete linear operator is shifted by one number of timesteps and at least one other linear operator is shifted by another number of timesteps.

31. The one or more non-transitory computer-readable media of claim 30, wherein each odd numbered linear operator is shifted by the one number of timesteps and each even linear operator is shifted by the another number of timesteps.

32. The one or more non-transitory computer-readable media of claim 27, wherein a width of the average is at least one of machine learned or manually specified.

33. The one or more non-transitory computer-readable media of claim 26, wherein the discrete linear operator is used to set one or more initial weights of a convolution operation that are subsequently refined by machine learning.

34. The one or more non-transitory computer-readable media of claim 20, wherein the at least one first operation includes at least two averages of different widths.

35. The one or more non-transitory computer-readable media of claim 20, wherein the at least one first operation includes at least one average computed via at least one of moving averages, cumulative moving averages, or exponentially moving averages.

36. The one or more non-transitory computer-readable media of claim 20, wherein the at least one first operation includes at least one average computed via one or more Gaussian filters.

37. The one or more non-transitory computer-readable media of claim 20, wherein the analytic function and the machine learned function are implemented as a single fused operation, thereby avoiding intermediate accesses to global memory.

38. The one or more non-transitory computer-readable media of claim 20, wherein the analytic function does not include learnable parameters, and at least one of intermediate output activations or gradients of the analytic function are not written to global memory for at least one of training or optimization.

39. A system, comprising:
one or more memories storing instructions; and
one or more processors that are coupled to the one or more memories and, when executing the instructions, are configured to:
execute at least one first operation on each component of one or more feature vectors along time and at least one second operation on one or more feature vectors along one or more feature dimensions,
wherein the at least one first operation is based on an analytic function and the at least one second operation is based on a machine learned function.
